(19) United States
(12) Patent Application Publication
(10) Pub. No.: US 2021/0206960 A1
(43) Pub. Date: Jul. 8, 2021

(54) AQUEOUS BINDER FORMULATION

(71) Applicant: BASF SE, Ludwigshafen am Rhein (DE)

(72) Inventors: Kathrin MICHL, Ludwigshafen (DE); Afsaneh NABIFAR, Ludwigshafen (DE)

(73) Assignee: BASF SE, Ludwigshafen am Rhei (DE)

(21) Appl. No.: 16/754,989

(22) PCT Filed: Oct. 19, 2018
(86) PCT No.: PCT/EP2018/078724

§ 371 Date: Apr. 9, 2020

(30) Foreign Application Priority Data
Oct. 27, 2017 (EP) 17198746.4

(51) Int. Cl. C08L 33/12; C08L 33/08; C08L 25/04; C08K 3/32; C08K 5/17

(52) U.S. Cl. CPC C08L 33/12; C08L 33/08; C08K 5/17; C08K 3/32; C08L 25/04

(57) ABSTRACT

Aqueous binder formulation comprising a copolymer having a glass transition temperature 80° C., a polyol compound and a phosphorus compound.

The present invention provides an aqueous binder formulation comprising
a) a copolymer A which in polymerized form is constructed from
   ≥20% and ≤50% by weight of at least one α,β-monoethylenically unsaturated C₃- to C₆-monocarboxylic acid (monomers A1) and
   ≥50% and ≤80% by weight of at least one other monoethylenically unsaturated compound (monomers A2),
   wherein the amounts of the monomers A1 and A2 sum to 100% by weight (total monomer amount) and wherein
      the copolymer A has a weight-average molecular weight in the range ≥5000 and ≤20 000 g/mol,
      the type and amounts of the monomers A1 and A2 are chosen such that the obtained copolymer A has a glass transition temperature Tg measured according to DIN EN ISO 11357-2 (2013-09) in the range ≥80° C. and
      ≥70 mol % of the carboxyl groups present in the copolymer A have been neutralized with a volatile base,
b) an organic compound B which comprises at least 2 hydroxyl groups (polyol B), wherein the amount of organic compound B is determined such that the molar ratio of carboxyl groups of copolymer A to hydroxyl groups of organic compound B is 10:1 to 1:1, and
c) a phosphorus-containing compound (phosphorus compound C), wherein the amount thereof is determined such that it is ≥3% and ≤20% by weight based on the amount of monomer A present in the copolymer A in polymerized form.

The present invention further provides a process for producing the binder formulation according to the invention, the use of the aqueous binder formulation for producing moldings, a process for producing moldings and the moldings themselves.

Aqueous binder formulations comprising a polycarboxylic acid and a compound having at least two hydroxyl groups and the use thereof for binding granular and/or fibrous substrates have been described many times before, for example in EP-A 882074, EP-A 882093 or EP-A 882094, and are therefore familiar to those skilled in the art.

it is known, inter alia from documents EP-A 583086 or EP-A 651088, that phosphorus-containing compounds act as accelerators in the thermal curing of the aqueous binders comprising polymeric polycarboxylic acids and polyols and are said to improve the mechanical properties, for example the wet strength, of the moldings obtained from the granular and/or fibrous substrates. Corresponding binder systems based on carboxylic acid-containing dispersion polymers in combination with polyol compounds and phosphorus-containing reaction accelerators are disclosed in EP-A 2071066 or EP-A 2070959 for example.

It is known from U.S. Pat. No. 5,294,686 that alkali metal salt hypophosphites are also employed as so-called radical chain transfer compounds which in the production of polymeric polycarboxylic acids reduce the molecular weight of the polymeric polycarboxylic acids obtained in the polymerization and thus the viscosity of the resulting polycarboxylic acid solutions.

It is also known from EP-A 1739128 that phosphorus-containing compounds, in particular alkali metal salt hypophosphites, are employed not only for producing low molecular weight polymeric polycarboxylic acid but also for accelerating the subsequent curing reaction. However, in the case of dual use (chain transfer agent/reaction accelerator) the relatively costly alkali metal salt hypophosphites need to be used in amounts of up to 40% by weight based on the total monomer amount.

WO 2016/191591 discloses binders for glass fiber mats which comprise a carboxyl-containing styrene copolymer and/or acrylate copolymer and polyols, polyepoxides, polycarbodiimides, polyaziridines or divalent metal carbonates as possible crosslinking components. The disclosed carboxyl-containing copolymers are said to have a content of carboxyl groups of not more than 12% by weight. A range from 3000 to 1 000 000 g/mol is disclosed as the average molecular weight. Only the examples disclose glass transition temperatures for the carboxyl-containing copolymers and these are in the range from 12° C. to 98° C. However, the examples do not disclose the specific chemical compositions of the particular copolymers. There is likewise no reference whatsoever in the entire document to the use of phosphorus-containing compounds.

The present invention accordingly has for its object to provide a further aqueous binder formulation for fibrous and/or granular substrates whose molding produced from the fibrous and/or granular substrate and the aqueous binder formulation exhibits advantageous properties in damp conditions, such as in particular an improved wet strength.

The object was achieved by providing the binder formulation defined at the outset.

The copolymer A employed according to the invention is in polymerized form constructed from
≥20% and ≤50% by weight of at least one α,β-monoethylenically unsaturated C₃- to C₆-monocarboxylic acid (monomers A1) and
≥50% and ≤80% by weight of at least one other monoethylenically unsaturated compound (monomers A2),
   wherein the amounts of the monomers A1 and A2 sum to 100% by weight (total monomer amount).

The monomers A1 are α,β-monoethylenically unsaturated C₃- to C₆-monocarboxylic acids, preferably C₃- or C₄-monocarboxylic acids, and their water-soluble salts fully or partially neutralized with a volatile base. These include for example acrylic acid, methacrylic acid, ethylacrylic acid, allylacetic acid, crotonic acid or vinylacetic acid. The monomer A1 is preferably selected from the group comprising acrylic acid, methacrylic acid and/or crotonic acid. It is particularly advantageous when the copolymer A comprises acrylic acid and/or methacrylic acid in polymerized form as monomers A1.

Contemplated monomers A2 in principle include all ethylenically unsaturated monomers distinct from the monomers A1 and copolymerizable therewith.

However, as monomers A2 the copolymer advantageously comprises in polymerized form
≥50% and ≤80% by weight of at least one monoethylenically unsaturated aromatic compound (monomers A2-1) and
≥0% and ≤40% by weight of at least one other monoethylenically unsaturated compound distinct from the monomers A1 and A2-1 (monomers A2-2),
   wherein the amounts of the monomers A2-1 and A2-2 sum to not more than 80% by weight of the total monomer amount.

Contemplated monomers A2-1 in principle include all monoethylenically unsaturated aromatic compounds, for example styrene, α-methylstyrene, o-chlorostyrene and o-, m- or p-vinyltoluene.

It is particularly advantageous when the copolymer A comprises styrene and/or α-methylstyrene in polymerized form as monomers A2-1.

Contemplated monomers A2-2 in principle include all other monoethylenically unsaturated compounds distinct from the monomers A1 and A2-1. Examples of monomers A2-2 include vinyl halides such as vinyl chloride or vinylidene chloride, esters of vinyl alcohol and monocarboxylic acids having 1 to 18 carbon atoms, preferably 2 to 12 carbon atoms, such as vinyl acetate, vinyl propionate, vinyl n-butyrate, vinyl laurate, and vinyl stearate, C₁- to C₁₂-alkyl vinyl ethers, such as methyl vinyl ether, ethyl vinyl ether, n-propyl vinyl ether, n-butyl vinyl ether, n-pentyl vinyl ether, n-hexyl vinyl ether, esters of α,β-monoethylenically unsaturated mono- and dicarboxylic acids having preferably 3 to 6 carbon atoms, such as especially acrylic acid, methacrylic acid, maleic acid, fumaric acid and itaconic acid, with alkanols generally having 1 to 12, preferably 1 to 8 and especially 1 to 4 carbon atoms, such as particularly the methyl, ethyl, n-butyl, isobutyl, pentyl, hexyl, heptyl, octyl, nonyl, decyl and 2-ethylhexyl esters of acrylic acid and of methacrylic acid, the dimethyl or di-n-butyl esters of fumaric acid and of maleic acid, nitriles of α,β-monoethylenically unsaturated carboxylic acids, such as acrylonitrile, methacrylonitrile, fumaronitrile, maleonitrile, and also C-s-conjugated dienes, such as 1,3-butadiene (butadiene). The abovementioned monomers form generally ≥90% by weight, preferably ≥95% by weight and especially preferably ≥98% by weight of the total amount of all monomers A2-2 and are thus the principal monomers A2-2. However, it is preferable according to the invention when the copolymer A comprises as the principal monomer A2-2 at least one ester of acrylic acid or methacrylic acid with a C₁- to C₁₂-alcohol, in particular methyl acrylate, ethyl acrylate, n-butyl acrylate, 2-ethylhexyl acrylate and/or methyl methacrylate, but preferably methyl methacrylate, n-butyl acrylate and/or 2-ethylhexyl acrylate, in polymerized form.

Also contemplated as monomers A2-2 in subordinate proportions are ethylenically unsaturated monomers which comprise either at least one sulfo group and/or the corresponding anion thereof or at least one amino, amido, ureido or N-heterocyclic group and/or the nitrogen-protonated or alkylated ammonium derivatives thereof. Examples include acrylamide and methacrylamide; and also vinylsulfonic acid, 2-acrylamido-2-methylpropanesulfonic acid, styrenesulfonic acid, and water-soluble salts thereof, and also N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide, and 2-(1-imidazolin-2-onyl)ethyl methacrylate. The abovementioned monomers A2-2 generally comprise a proportion of ≤10% by weight, preferably ≤5% by weight and especially ≤2% by weight, in each case based on the total amount of incorporated monomers A2-2. However, it is advantageous when no such ethylenically unsaturated monomers A2-2 are incorporated.

Monomers A2-2 which typically increase the integrity of the films formed by a polymer matrix normally have at least one epoxy group, at least one carbonyl group, or at least two nonconjugated ethylenically unsaturated double bonds. Examples thereof include monomers comprising two vinyl moieties, monomers having two vinylidene moieties and also monomers having two alkenyl moieties. Particularly advantageous monomers here are the diesters of dihydric alcohols with α,β-monoethylenically unsaturated monocarboxylic acids, preference among these being given to acrylic and methacrylic acid. Examples of such monomers comprising two nonconjugated ethylenically unsaturated double bonds include alkylene glycol diacrylates and alkylene glycol dimethacrylates, for example ethylene glycol diacrylate, propylene 1,2-glycol diacrylate, propylene 1,3-glycol diacrylate, butylene 1,3-glycol diacrylate, butylene 1,4-glycol diacrylate and ethylene glycol dimethacrylate, propylene 1,2-glycol dimethacrylate, propylene 1,3-glycol dimethacrylate, butylene glycol 1,3-dimethacrylate, butylene glycol 1,4-dimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate, and triallyl isocyanurate. The abovementioned monomers A2-2 generally comprise a proportion of 10% by weight, preferably 5% by weight and especially 2% by weight, in each case based on the total amount of incorporated monomers A2-2. However, it is advantageous when no such ethylenically unsaturated monomers A2-2 are incorporated.

It is particularly advantageous when the copolymer A comprises methyl methacrylate, n-butyl acrylate and/or 2-ethylhexyl acrylate in polymerized form as monomers A2-2.

Copolymer A thus advantageously comprises in polymerized form acrylic acid and/or methacrylic acid as monomers A1, styrene and/or α-methylstyrene as monomers A2-1 and methyl methacrylate, n-butyl acrylate and/or 2-ethylhexyl acrylate as monomers A2-2.

It is advantageous according to the invention when the copolymer A comprises 30% by weight and ≤45% by weight of monomers A1, ≥55% and ≤70% by weight of monomers A2-1 and ≥0% and ≤20% by weight of monomers A2-2.

It is advantageous according to the invention when the copolymer A in polymerized form is constructed from
≥30% and ≤45% by weight of acrylic acid,
≥20% and ≤65% by weight of styrene,
≥20% and ≤40% by weight of α-methylstyrene and
≥0% and ≤20% by weight of methyl methacrylate, n-butyl acrylate and/or 2-ethylhexyl acrylate.

According to the invention the type and amounts of the monomers A1 and A2 (or A2-1 und A2-2) in the production of the copolymer A are chosen such that the obtained copolymer A has a glass transition temperature Tg measured according to DIN EN ISO 11357-2 (2013-09) in the range ≥80° C., advantageously in the range ≥90° C. and ≤150° C.

It is also important according to the invention that the copolymer A has a weight-average molecular weight in the range ≥5000 and ≤20 000 g/mol and especially advantageously in the range ≥5500 and ≤18 000 g/mol. In the context of this document the determination of the weight-average molecular weight shall be carried out by gel permeation chromatography using defined polystyrene standards dissolved in tetrahydrofuran for calibration.

Production of the copolymer A is familiar to those skilled in the art and is carried out for example by radical-initiated solution, dispersion or bulk polymerization of the relevant amounts of ethylenically unsaturated monomers A1 and A2 using a radical initiating compound (radical initiator), such as are disclosed for example in WO 2017/017090, page 12, lines 1 to 25, and a corresponding amount of radical chain transfer compounds (radical chain transfer agent), such as are disclosed for example in WO 2017/017090, page 13, line 31 to page 14 line 12, or by radical-initiated solution or bulk polymerization at temperatures ≥150° C. It is advantageous when the radical-initiated solution or bulk polymerization is carried out at these elevated temperatures in a tubular reactor, a continuously operated stirred tank or a continuously operated stirred tank cascade (see in this regard for example U.S. Pat. Nos. 4,414,370, 4,529,787, 4,546,160, 9,238,699). However, it is preferable when the production of the copolymer A is carried out in bulk or optionally in the presence of a solvent by polymerization of the monomers A1 and A2 at a temperature ≥160° C. and ≤310° C., particularly advantageously at a temperature in the range ≥180° C. and ≤250° C. using at least one continuously operated stirred tank reactor. If solvents are employed in this high temperature operating mode then solvents inert at the reaction temperature are selected, for example xylene, toluene, ethylbenzene, aromatics mixtures (for example Aromatic-100®, Aromatic-150® or Aromatic-200®, from Exxon), acetone, methyl ethyl ketone, N-methyl pyrrolidone and/or carbitol, the amount of which is generally ≤40% by weight, often ≥5% and ≤15% by weight, based on the total monomer amount. The polymerization is advantageously carried out under pressure at 1 to 10 bar (positive pressure) and an average residence time of ≥2 and ≤30 minutes, wherein an average residence time of ≥10 and ≤25 minutes is preferred. It is particularly advantageous when the polymerization mixture discharged from the at least one continuously operated stirred tank reactor is immediately passed through a likewise continuous falling film evaporator in which any unconverted monomers A1 and A2 and any solvent present are distilled off, the obtained copolymer A often being obtained in the form of finely divided flakes. Corresponding products are marketed by BASF SE under the brand name Joncryl®.

The binder formulation according to the invention comprises as a further essential component an organic compound B comprising at least 2 hydroxyl groups (polyol B).

Compounds employable as polyol B in principle include any organic compounds comprising at least two hydroxyl groups. The polyol B may be a compound having a molecular weight ≤1000 g/mol or a polymeric compound having a molecular weight >1000 g/mol. Examples of polymeric compounds having at least 2 hydroxyl groups include polyvinyl alcohol, partially hydrolyzed polyvinyl acetate, homo- or copolymers of hydroxyalkyl acrylates or hydroxyalkyl methacrylates, for example hydroxyethyl acrylate/methacrylate or hydroxypropyl acrylate/methacrylate but also saccharide compounds, such as monosaccharide, disaccharide, oligosaccharide and polysaccharide compounds and derivatives thereof. Examples of further polymeric polyols B employable according to the invention may be found inter alia in WO 97/45461, page 3, line 3 to page 14, line 33.

Compounds contemplated as polyol B having a molecular weight ≤1000 g/mol include any organic compounds having at least 2 hydroxyl groups and a molecular weight ≤1000 g/mol. Examples include ethylene glycol, propylene 1,2-glycol, glycerol, 1,2- or 1,4-butanediol, pentaerythritol, trimethylolpropane, sorbitol, sucrose, glucose, 1,2-, 1,3- or 1,4-dihydroxybenzene, 1,2,3-trihydroxybenzene, 1,2-, 1,3- or 1,4-dihydroxycyclohexane and preferably an alkanolamine, for example a compound of general formula (1)

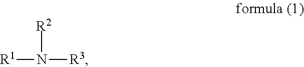

in which R¹ represents an H atom, a C₁- to C₁₀-alkyl group or a C₂- to C₁₀-hydroxyalkyl group and R² and R³ represent a C₂- to C₁₀-hydroxyalkyl group.

It is particularly preferable when R² and R³ independently of one another represent a C₂- to C₅-hydroxyalkyl group and R¹ represents an H atom, a C₁- to C₅-alkyl group or a C₂- to C₅-hydroxyalkyl group.

Compounds of formula (1) especially include diethanolamine, triethanolamine, diisopropanolamine, triisopropanolamine, methyldiethanolamine, butyldiethanolamine and/or methyldiisopropanolamine.

Examples of further polyols B having a molecular weight 1000 g/mol employable according to the invention may likewise be found in WO 97/45461, page 3, line 3 to page 14, line 33. Examples of further polyols B with a molecular weight ≤1000 g/mol and >1000 g/mol may also be found in WO 99/09100, page 13, line 29 to page 24, line 32. As a result of the explicit reference thereto the recited polyols B are to be regarded as an integral constituent of this document.

The polyol B is preferably an alkanolamine. This is especially selected from the group comprising diethanolamine, triethanolamine, diisopropanolamine, triisopropanolamine, methyldiethanolamine, butyldiethanolamine and/or methyldiisopropanolamine, wherein triethanolamine is particularly preferred.

In the process according to the invention the amount of the at least one polyol B is advantageously determined such that the molar ratio of the carboxyl groups of copolymer A to the hydroxyl groups of the organic compound B is 10:1 to 1:1, advantageously 5:1 to 1:1 and especially advantageously 2.5:1 to 1.1:1.

The binder formulation according to the invention comprises as a further essential component a phosphorus-containing compound (phosphorus compound C), wherein in principle this may be an organic or an inorganic phosphorus compound.

Phosphorus compounds C suitable according to the invention are disclosed in particular in EP-A 583086, page 6, lines 18 to 26 and in EP-A 651088, page 5, lines 30 to 39. As a result of the explicit reference thereto the phosphorus compounds disclosed in these two documents are to be regarded as phosphorus compounds C disclosed in the present document. These are in particular alkali metal hypophosphites, phosphites, polyphosphates, dihydrogenphosphates, polyphosphoric acid, hypophosphoric acid, phosphoric acid, alkylphosphinic acid or oligomers/polymers of these salts and acids. However, in the present invention sodium hypophosphite and/or sodium hypophosphite monohydrate are particularly advantageously employed as phosphorus compound C.

The amount of phosphorus compound C present is determined such that it is ≥3% and ≤20% by weight, advantageously ≥5% and ≤16% by weight, and especially advantageously ≥7% and ≤14% by weight in each case based on the amount of monomer A1 present in copolymer A in polymerized form.

It is essential to the invention that ≥70 mol %, advantageously ≥80 mol % and especially advantageously 100 mol % of the carboxyl groups present in the copolymer A have been neutralized with a volatile base.

In the context of the present document volatile bases are to be understood as meaning any organic or inorganic compounds which have a pKa >5 and are volatilized in the thermal treatment during production of the moldings from granular and/or fibrous substrates. These are advantageously organic or inorganic basic compounds having a boiling point of less than or equal to the temperature prevailing in the production of the moldings from granular and/or fibrous substrates during the thermal treatment step. The volatile bases particularly advantageously have a boiling point ≤110° C., advantageously ≤50° C. and especially advantageously ≤0° C. in each case at 1.013 bar (absolute).

Such basic compounds are familiar to those skilled in the art. Examples thereof include ammonia and primary, secondary or tertiary organic amines, for example methylamine, ethylamine, 1-propylamine, 2-propylamine, 1-n-butylamine, 2-n-butylamine, 2-methyl-1-propylamine, 2-methyl-2-propylamine etc., dimethylamine, diethylamine, di-n-propylamine, di-iso-propylamine, di-n-butylamine, di-2-methylpropylamine etc., trimethylamine, triethylamine, tri-n-propylamine, triisopropylamine, tri-n-butylamine, tri-2-methylpropylamine etc., but also mixed amines, such as N-methyl-N-ethylamine, N,N-dimethyl-N-ethylamine etc. But neutralization of the carboxyl groups of the copolymer A is advantageously effected using bases having a boiling point of ≤110° C., advantageously ≤50° C. and especially advantageously ≤0° C. at a pressure of 1.013 bar (absolute), such as in particular ammonia, in particular in the form of an aqueous solution thereof. However, in the context of the present document volatile bases are to be understood as also including the basic ammonium salts ammonium carbonate [(NH₄)₂CO₃] and ammonium hydrogencarbonate [NH₄HCO₃] which decompose into volatile gaseous constituents during the thermal treatment step. However, it is particularly preferable to employ ammonia, in particular in the form of its aqueous solution, for neutralization of the carboxyl groups of the copolymer A.

In a preferred embodiment the aqueous binder formulation according to the invention comprises ≤0.1% by weight, in particular ≤0.01% by weight and especially none is added whatsoever of other bases distinct from the volatile bases, such as in particular sodium hydroxide, potassium hydroxide, calcium hydroxide etc. What is important in this connection is that according to the invention the volatile base may be added to neutralize the carboxyl groups both during or after production of the copolymer A and during production of the aqueous binder formulation. If the volatile base is for example to be added during production of the copolymer A then the volatile base may be added in the form of a correspondingly neutralized monomer A1. However, it is also possible to add the volatile base to the polymerization mixture as a separate component. Accordingly the volatile base may be added to neutralize the carboxyl groups of the copolymer A after production thereof. These abovementioned process variants are employed especially when the copolymer A was produced by customary solution or emulsion polymerization.

However, it is particularly advantageous when the neutralization of the carboxyl groups present in the copolymer A using the aqueous base is carried out during the production of the aqueous binder formulation when the copolymer A is employed in solid/flake form, such as is formed in the production of the copolymer A by polymerization of the monomers A1 and A2 at a temperature ≥160° C. and ≤310° C. in bulk or optionally in the presence of a solvent with subsequent solvent removal (as described hereinabove).

It is advantageous according to the invention when the production of an aqueous binder formulation is carried out such that in a reaction vessel
water, advantageously deionized water, and the copolymer A are advantageously initially charged in solid/flake form at room temperature (20° C. to 25° C.), then
the reaction vessel is inertized with nitrogen, then
the copolymer A/water mixture is heated with stirring to a temperature ≥50° C. und ≤90° C., then
at this temperature with stirring the volatile base of the copolymer A/water mixture is added, wherein the copolymer A is generally at least partially dissolved or dispersed, then
the polyol B and the phosphorus compound C are added to the reaction mixture with stirring, before or after cooling to room temperature.

However, it is important that the aqueous binder formulation according to the invention may further comprise customary auxiliaries typical for the application that are familiar to the person skilled in the art, for example pigments, fillers, coalescing agents, flame retardants, surfactants, biocides, plasticizers, antifoams, corrosion inhibitors, antistats, acids, buffering substances, lubricants, antioxidants, silane coupling reagents etc., as a result of which not only the nonadditized, but also the additized, aqueous binder formulations shall be comprised according to the invention. These auxiliaries typical for the application may be added during or after production of the aqueous binder formulation. These optional auxiliaries are advantageously added to the aqueous binder formulation after production thereof.

The recited aqueous binder formulations are advantageously suitable for use in the production of moldings from granular and/or fibrous substrates. The recited aqueous binder formulations are therefore advantageously employable for producing moldings from fibrous and/or granular substrates.

Granular and/or fibrous substrates are familiar to those skilled in the art. These comprise for example wood chips, wood fibers, cellulose fibers, textile fibers, polymer fibers, glass fibers, mineral fibers, stone wool or natural fibers such as jute, flax, hemp or sisal, but also cork chips or sand, and other organic or inorganic natural and/or synthetic fibrous and/or granular compounds whose longest dimension in the case of granular substrates is ≤10 mm, preferably ≤5 mm and especially ≤2 mm. It will be appreciated that the term “substrate” shall also include the nonwoven fabrics obtainable from fibers, for example so-called mechanically consolidated (for example needled) or chemically prebonded nonwoven fabrics prebonded with melamine/formaldehyde resins for example. The aqueous binder formulation according to the invention is especially advantageously suitable as a formaldehyde-free binder system for the abovementioned fibers/nonwoven fabrics formed therefrom, wherein the nonwoven fabrics are particularly preferred.

The process for producing a molding from granular and/or fibrous substrates and the aqueous binder formulation according to the invention is advantageously carried out such that the aqueous binder formulation according to the invention is applied to the granular and/or fibrous substrate, the thus-treated granular and/or fibrous substrate is optionally shaped and subsequently the thus-obtained granular and/or fibrous substrate is subjected to a thermal treatment step at a temperature ≥110° C., preferably ≥140° C. and ≤220° C. or ≥160° C. and ≤220° C. and especially preferably ≥180° C. and ≤200° C.

The treatment of the granular and/or fibrous substrate with the aqueous binder formulation according to the invention is generally carried out such that the aqueous binder formulation according to the invention is uniformly applied to the surface of the granular and/or fibrous substrate. The amount of aqueous binder formulation is chosen such that per 100 g of granular and/or fibrous substrate ≥0.1 g and ≤100 g, preferably ≥1 g and ≤50 g and especially preferably ≥5 g and ≤30 g of binder formulation (corresponding to sum of the total amounts of copolymer A, polyol B and phosphorus compound C calculated as solids) are employed. The uniform application of the aqueous binder formulation to the surface of the granular and/or fibrous substrate (the so-called impregnation) is familiar to those skilled in the art and is effected for example by soaking or by spraying the granular and/or fibrous substrate.

After the impregnation, the granular and/or fibrous substrate is optionally brought into the desired shape, for example by introduction into a heatable press or mold. The shaped, impregnated granular and/or fibrous substrate is subsequently dried and cured in a manner familiar to those skilled in the art.

The drying/curing of the optionally shaped, impregnated granular and/or fibrous substrate is often carried out in two temperature stages, wherein the drying stage is carried out at a temperature <110° C., preferably ≥20° C. and ≤100° C. and especially preferably ≥40° C. and ≤100° C., and the curing stage is carried out at a temperature ≥110° C., preferably ≥140° C. and ≤220° C. and especially preferably ≥180° C. and ≤200° C.

The drying stage is advantageously carried out such that at a temperature <100° C. drying is carried out until the optionally shaped, impregnated granular and/or fibrous substrate which is often not yet in its final shape (so-called semifinished product), has a residual moisture content ≤30% by weight, preferably ≤15% by weight and especially preferably ≤10% by weight. The residual moisture content is generally determined by weighing about 1 g of the obtained impregnated and dried substrate at room temperature, subsequently storing it in a drying cabinet at 110° C. for 2 minutes before allowing it to cool again and re-weighing it at room temperature.

The residual moisture content corresponds to the difference in weight of the impregnated and dried substrate before and after storage in a drying cabinet at 110° C. based on the weight of the impregnated and dried substrate before storage in a drying cabinet multiplied by the factor 100.

The thus-obtained impregnated and dried substrate is generally still deformable after heating to a temperature of up to about 100° C. and may be brought into the final shape of the desired molding at this temperature.

The subsequent curing stage is advantageously carried out such that the impregnated and dried substrate is heated at a temperature of ≥110° C. until it has a residual moisture content of ≤0.5% by weight, preferably ≤0.1% by weight or ≤0.01% by weight and especially preferably ≤0% by weight, the binder curing as a result of a chemical esterification reaction.

The production of the moldings is preferably carried out such that the impregnated and dried substrate is brought into the final shape in the abovementioned temperature ranges in a compression mold and subsequently cured.

It will be appreciated that it is alternatively also possible for the drying stage and the curing stage of the impregnated granular and/or fibrous substrate to be carried out in one operating step, for example in a compression mold.

The moldings obtainable by the abovementioned processes shall thus correspondingly also be comprised according to the invention.

The moldings obtainable via the aqueous binder formulations according to the invention have advantageous properties in damp environments, such as in particular an improved wet tear strength.

The present document accordingly comprises the following embodiments:
1.) Aqueous binder formulation comprising
   a) a copolymer A which in polymerized form is constructed from
      ≥20% and ≤50% by weight of at least one α,β-monoethylenically unsaturated C₃- to C₆-monocarboxylic acid (monomers A1) and
      ≥50% and ≤80% by weight of at least one other monoethylenically unsaturated compound (monomers A2),
      wherein the amounts of the monomers A1 and A2 sum to 100% by weight (total monomer amount) and wherein
         the copolymer A has a weight-average molecular weight in the range ≥5000 and ≤20 000 g/mol,
         the type and amounts of the monomers A1 and A2 are chosen such that the obtained copolymer A has a glass transition temperature Tg measured according to DIN EN ISO 11357-2 (2013-09) in the range 2 80° C. and
         ≥70 mol % of the carboxyl groups present in the copolymer A have been neutralized with a volatile base,
   b) an organic compound B which comprises at least 2 hydroxyl groups (polyol B), wherein the amount of organic compound B is determined such that the molar ratio of carboxyl groups of copolymer A to hydroxyl groups of organic compound B is 10:1 to 1:1, and
   c) a phosphorus-containing compound (phosphorus compound C), wherein the amount thereof is determined such that it is 3% and 20% by weight based on the amount of monomer A1 present in the copolymer A in polymerized form.
2.) Aqueous binder formulation according to embodiment 1, wherein the copolymer A comprises in polymerized form as monomers A2
   ≥50% and ≤80% by weight of at least one monoethylenically unsaturated aromatic compound (monomers A2-1) and
   ≥0% and ≤40% by weight of at least one other monoethylenically unsaturated compound distinct from the monomers A1 and A2-1 (monomers A2-2),
   wherein the amounts of the monomers A2-1 and A2-2 sum to not more than 80% by weight of the total monomer amount.
3.) Aqueous binder formulation according to either of embodiments 1 or 2, wherein the copolymer A comprises in polymerized form acrylic acid and/or methacrylic acid as monomers A1, styrene and/or α-methylstyrene as monomers A2-1 and methyl methacrylate, n-butyl acrylate and/or 2-ethylhexyl acrylate as monomers A2-2.
4.) Aqueous binder formulation according to any of embodiments 1 to 3, wherein the amount of monomers A1 is ≥30% and ≤45% by weight, the amount of monomers A2-1 is ≥55% and ≤70% by weight and the amount of monomers A2-2 is ≥0% and ≤20% by weight.
5.) Aqueous binder formulation according to any of embodiments 1 to 4, wherein the copolymer A in polymerized form is constructed from
   ≥30% and ≤45% by weight of acrylic acid,
   ≥20% and ≤65% by weight of styrene,
   ≥0% and ≤40% by weight of α-methylstyrene and
   ≥0% and ≤20% by weight of methyl methacrylate, n-butyl acrylate and/or 2-ethylhexyl acrylate.
6.) Aqueous binder formulation according to any of embodiments 1 to 5, wherein an alkanolamine is employed as polyol B.
7.) Aqueous binder formulation according to any of embodiments 1 to 6, wherein the amount of polyol B is chosen such that the molar ratio of the carboxyl groups of copolymer A to the hydroxyl groups of polyol B is 2.5:1 to 1.1:1.
8.) Aqueous binder formulation according to any of embodiments 1 to 7, wherein sodium hypophosphite and/or sodium hypophosphite monohydrate is employed as phosphorus compound C.
9.) Aqueous binder formulation according to any of embodiments 1 to 8, wherein an organic or inorganic basic compound having a boiling point ≤110° C. at 1.013 bar (absolute) is employed as volatile base.
10.) Aqueous binder formulation according to any of embodiments 1 to 9, wherein the copolymer A has been produced in bulk or optionally in the presence of a solvent by polymerization of the monomers A1 and A2 at a temperature ≥160° C. and ≤310° C. using at least one continuously operated stirred tank reactor.
11.) Processes for producing an aqueous binder formulation according to any of embodiments 1 to 10, wherein in a reaction vessel
   water and the copolymer A are initially charged at room temperature, then
   the reaction vessel is inertized with nitrogen, then
   the copolymer A/water mixture is heated with stirring to a temperature ≥50° C. and ≤90° C., then
   at this temperature with stirring the volatile base is added to the copolymer A/water mixture, then
   the polyol B and the phosphorus compound C are added with stirring to the reaction mixture, before or after cooling to room temperature.
12.) Use of a binder formulation according to any of embodiments 1 to 10 for producing moldings from granular and/or fibrous substrates.
13.) Processes for producing a molding from granular and/or fibrous substrates, wherein an aqueous binder formulation according to any of embodiments 1 to 10 is applied to the granular and/or fibrous substrate, optionally the thus-treated granular and/or fibrous substrate is brought into shape and subsequently the thus-obtained granular and/or fibrous substrate is subjected to a thermal treatment step at a temperature ≥110° C.
14.) Processes for producing a molding according to embodiment 13, wherein the amount of aqueous binder formulation is chosen such that per 100 g of granular and/or fibrous substrate ≥1 and ≤100 g of binder (corresponding to sum of the total amounts of copolymer A, polyol B and phosphorus compound C calculated as solids) are employed.
15.) Molding obtainable by a process according to either of embodiments 13 or 14.

The invention shall be elucidated with reference to the nonlimiting examples which follow.

### EXAMPLES

To produce the aqueous binder liquors the copolymers A1 to A5 and V1 and V2 were employed, the production of which employed the constituents reported in table 1 which follows according to the procedure disclosed in U.S. Pat. No. 4,529,787 and the characterization of which is likewise reported in table 1 which follows.

TABLE 1
Characterization of copolymers A1 to A5 and V1 and V2 used for producing the binder liquors.

| | Copolymer | | | | | | |
|---|---|---|---|---|---|---|---|
| | A1 | V1 | V2 | A2 | A3 | A4 | A5 |
| Constituent: | | | | | | | |
| acrylic acid [% by wt] | 45 | 34 | 9.6 | 38 | 40 | 39 | 30 |
| styrene [% by wt] | | 33 | 24.4 | 62 | 21 | 54 | 36 |
| α-methylstyrene [% by wt] | 45 | 33 | — | — | 27 | 7 | 29 |
| methyl methacrylate [% by wt] | 10 | — | 50.4 | — | 10 | — | — |
| N-butyl acrylate [% by wt] | — | — | 15.6 | — | — | — | 5 |
| 2-ethylhexyl acrylate [% by wt] | — | — | — | — | 2 | — | — |
| Polymer properties: | | | | | | | |
| weight average | | | | | | | |
| molecular weight [Mw] | 5500 | 1690 | 15 630 | 6930 | 13 290 | 16 890 | 17 160 |
| glass transition temperature | 121 | 56 | 80 | 123 | 97 | 88 | 128 |
| [° C.] | | | | | | | |

To produce the binder liquors the copolymers A1 to A5 and V1 and V2 were initially charged into a stirred tank at room temperature together with deionized water, the stirred tank is then inertized with nitrogen, copolymer A/water mixture is then heated to a temperature (dependent on the particular copolymer A) in the range from ≥50° C. and ≤90° C. with stirring, a 25% by weight aqueous solution of ammonia as the volatile base was then added with stirring and the obtained mixture was stirred at this temperature for about 2 to 3.5 hours to at least partially dissolve the respective copolymer A and disperse any remaining residue. The respective reaction mixture was subsequently cooled back down to room temperature. The thus-obtained aqueous copolymer systems are referred to as copolymer solutions A1 to A5 and V1 and V2 according to the employed copolymer A. The components employed to produce the copolymer solutions A1 to A5 and V1 and V2 having a copolymer content of 27% by weight are listed in table 2 which follows.

TABLE 2
List of components employed to produce copolymer
solutions A1 to A5 and V1 and V2 [in % by wt]

| | Copolymer solution | | | | | | |
|---|---|---|---|---|---|---|---|
| Constituent | A1 | V1 | V2 | A2 | A3 | A4 | A5 |
| copolymer A | 27.0 | 27.0 | 27.0 | 27.0 | 27.0 | 27.0 | 27.0 |
| ammonia solution | 11.5 | 8.7 | 2.5 | 9.7 | 10.2 | 9.9 | 7.6 |
| deionized water | 61.5 | 64.3 | 70.5 | 63.3 | 62.8 | 63.1 | 65.4 |

Using the copolymer A1 two further copolymer solutions were furthermore produced analogously to the production of the copolymer solution A1, wherein one was made up with 27.0% by weight of copolymer A1, 27.0% by weight of a 25% aqueous solution of sodium hydroxide and 46.0% by weight of deionized water, corresponding to copolymer solution 33, and the other is made up with 27.0% by weight of copolymer A1, 17.1% by weight of triethylamine and 55.9% by weight of deionized water, corresponding to copolymer solution A6.

### Performance Tests:

To produce the aqueous binder liquor concentrates 1850 g of the respective abovementioned 27% by weight aqueous copolymer solutions A1 to A6 and V1 to V3 were initially charged in a 5 l beaker at room temperature, the amount of crosslinker triethanolamine (TEA) or glycerol and sodium hypophosphite (SHP) indicated in table 3 was added with stirring and the mixture was mixed until homogeneous. 0.3% by weight of 3-aminopropyltriethoxysilane based on the solids content (sum of nonaqueous components) of the respective binder liquor concentrate was then added to these mixtures and the mixture was then mixed until homogeneous by stirring. The respective binder liquor concentrates obtained were subsequently adjusted to a copolymer solids content of 4% by weight by addition of deionized water. The thus-obtained homogeneous mixtures are referred to as binder liquors C1 to C10 and V1 to V6.

TABLE 3
Formulation of binder liquor concentrates

| Binder liquor | copolymer | | | |
|---|---|---|---|---|
| concentrate | solution | crosslinker | | SHP |
| V1 | A1 | — | | — |
| V2 | A1 | 60 | g TEA | — |
| V3 | A1 | — | | 15 g |
| V4 | V3 | 60 | g TEA | 15 g |
| V5 | V1 | 60 | g TEA | 15 g |
| V6 | V2 | 60 | g TEA | 15 g |
| C1 | A1 | 60 | g TEA | 15 g |
| C2 | A1 | 15 | g TEA | 15 g |
| C3 | A1 | 120 | g TEA | 15 g |
| C4 | A1 | 60 | g TEA | 30 g |
| C5 | A6 | 60 | g TEA | 15 g |
| C6 | A1 | 60 | g glycerol | 15 g |
| C7 | A2 | 60 | g TEA | 15 g |
| C8 | A3 | 60 | g TEA | 15 g |
| C9 | A4 | 60 | g TEA | 15 g |
| C10 | A5 | 60 | g TEA | 15 g |

Nonwoven glass fiber fabrics (57×46 cm) from Whatman, GF/A No. 1820-915, having a basis weight of 53 g/m² were employed to produce the moldings.

To apply the binder liquors (impregnation), the glass fiber nonwoven fabrics were passed longitudinally through the abovementioned 4% by weight aqueous binder liquors C1 to C10 and V1 to V6 using a continuous PES sieve belt at a belt speed of 60 cm per minute. By subsequent aspiration of the aqueous binder liquors the wet application rate was adjusted such that 10.8 g/m² of copolymer (calculated as solids) were present in the nonwoven glass fiber fabric. The thus obtained impregnated nonwoven glass fiber fabrics were dried and cured for 3 minutes at 180° C. in a Mathis oven using a plastic mesh as a support at maximum hot air flow. After cooling to room temperature test strips having dimensions of 240×50 mm were cut to size in the longitudinal fiber direction. The obtained test strips were subsequently stored for 24 hours in a climate controlled room at 23° C. and 50% relative atmospheric humidity. The nonwoven glass fiber fabric test strips obtained using the employed binder liquors C1 to C10 and V1 to V6 are hereinbelow referred to as test strips C1 to C10 and V1 to V6.

### Wet Tear Strength Determination

To determine the wet tear strength the respective test strips were stored in deionized water at 80° C. for 15 minutes before excess water was dabbed off with a cotton fabric prior to measurement. Determination of tear strength was carried out on a Zwick-Roell Z005 tensile tester. Test strips C1 to C10 and V1 to V6 were introduced vertically into a clamping device such that the free clamped length was 200 mm. The clamped test strips were subsequently pulled apart in opposite directions at a speed of 25 mm/minute until the test strips tore. The higher the force required to tear the test strips, the better the assessment of the corresponding tear strength. 5 measurements were carried out in each case. The values reported in table 4 are the averages of the measurements obtained in each case.

TABLE 4
Summary of wet tear strength results [Values
reported in N/50 mm in each case]

| Test strip | wet tear strength |
|---|---|
| V1 | 17 |
| V2 | 22 |
| V3 | 22 |
| V4 | 2 |
| V5 | 21 |
| V6 | 31 |
| C1 | 78 |
| C2 | 70 |
| C3 | 79 |
| C4 | 93 |
| C5 | 71 |
| C6 | 35 |
| C7 | 64 |
| C8 | 65 |
| C9 | 71 |
| C10 | 61 |

Comparison of the wet tear strength results shows that the values for the inventive examples C1 to C10 are markedly higher than the values for the corresponding comparative examples V1 to V6.

1: An aqueous binder formulation, comprising:
a) a copolymer A, comprising, in polymerized form,
≥20% and ≤50% by weight of at least one α,β-monoethylenically unsaturated C₃- to C₆-monocarboxylic acid (A1) and
≥50% and ≤80% by weight of at least one other monoethylenically unsaturated compound (A2),
wherein a total amount of A1 and A2 is 100% by weight,
the copolymer A has a weight-average molecular weight in a range of from ≥5000 to ≤20 000 g/mol,
the copolymer A has a glass transition temperature Tg in a range of ≥80° C., measured according to DIN EN ISO 11357-2 (2013-09), and
≥70 mol % of carboxyl groups present in the copolymer A have been neutralized with a volatile base;
b) an organic compound which comprises at least 2 hydroxyl groups (polyol B), wherein an amount of the polyol B is determined such that a molar ratio of carboxyl groups present in the copolymer A to hydroxyl groups present in the polyol B is in a range of from 10:1 to 1:1; and
c) a phosphorus-containing compound (phosphorus compound C), wherein an amount of the phosphorous compound is ≥3% and ≤20% by weight based on an amount of A1 present in the copolymer A in polymerized form.

2: The aqueous binder formulation of claim 1, wherein the copolymer A comprises, in polymerized form, as A2;
≥50% and ≤80% by weight of at least one monoethylenically unsaturated aromatic compound (A2-1) and
≥0% and ≤40% by weight of at least one other monoethylenically unsaturated compound distinct from A1 and A2-1,
wherein a total amount of A2-1 and A2-2 is not more than 80% by weight of the total amount of A1 and A2.

3: The aqueous binder formulation of claim 1, wherein the copolymer A comprises, in polymerized form, acrylic acid and/or methacrylic acid as A1 and, as A2, styrene and/or α-methylstyrene (A2-1) and methyl methacrylate, n-butyl acrylate and/or 2-ethylhexyl acrylate (A2-2).

4: The aqueous binder formulation of claim 1, wherein the copolymer A comprises in polymerized form, as A2:
at least one monoethylenically unsaturated aromatic compound (A2-1), and
at least one other monoethylenically unsaturated compound distinct from A1 and A2-1 (A2-2),
wherein an amount of A1 is ≥30% and ≤45% by weight, an amount of A2-1 is ≥55% and ≤70% by weight and a amount of A2-2 is ≥0% and ≤20% by weight.

5: The aqueous binder formulation of claim 1, wherein the copolymer A comprises, in polymerized form,
≥30% and ≤45% by weight of acrylic acid,
≥20% and ≤65% by weight of styrene,
≥0% and ≤40% by weight of α-methylstyrene and
≥0% and ≤20% by weight of methyl methacrylate, n-butyl acrylate and/or 2-ethylhexyl acrylate.

6: The aqueous binder formulation of claim 1, wherein an alkanolamine is employed as the polyol B.

7: The aqueous binder formulation of claim 1, wherein an amount of the polyol B is determined such that a molar ratio of carboxyl groups present in the copolymer A to hydroxyl groups present in the polyol B is in a range of from 2.5:1 to 1.1:1.

8: The aqueous binder formulation of claim 1, wherein sodium hypophosphite and/or sodium hypophosphite monohydrate is (are) employed as the phosphorus compound C.

9: The aqueous binder formulation of claim 1, wherein an organic or inorganic basic compound having a boiling point ≤110° C. at 1.013 bar (absolute) is employed as the volatile base.

10: The aqueous binder formulation of claim 1, wherein the copolymer A has been produced in bulk or optionally in the presence of a solvent by polymerization of A1 and A2 at a temperature in a range of from 160° C. to ≤310° C. employing at least one continuously operated stirred tank reactor.

11: A process for producing the aqueous binder formulation of claim 1, the process comprising, in a reaction vessel:
initially charging water and the copolymer A at room temperature, to obtain a mixture of water and the copolymer A, then
inerting the reaction vessel with nitrogen, then
heating the mixture of water and the copolymer A, with stirring, to a temperature in a range of from ≥50° C. to ≤90° C., then
adding, at said temperature with stirring, the volatile base to the mixture of water and the copolymer A, to obtain a reaction mixture, and then
adding the polyol B and the phosphorus compound C to the reaction mixture with stirring, before or after cooling to room temperature.

12: A process for producing a molding from a granular and/or fibrous substrate, the process comprising obtaining the aqueous binder formulation of claim 1.

13: A process for producing a molding from agranular and/or fibrous substrate, the process comprising applying the aqueous binder formulation of claim 1 to the granular and/or fibrous substrate, optionally shaping the thus-treated granular and/or fibrous substrate and subsequently subjecting the thus-obtained granular and/or fibrous substrate to thermal treatment at a temperature in a range of ≥110° C.

14: The process of claim 13, wherein an amount of aqueous binder formulation is determined such that ≥1 and ≤100 g of binder (corresponding to a total amount of the copolymer A, the polyol B and the phosphorus compound C calculated as solids) is employed per 100 g of granular and/or fibrous substrate.

15: A shaped body, obtainable by the process of claim 13.
